(19) United States
(12) Patent Application Publication
(10) Pub. No.: US 2015/0257426 A1
(43) Pub. Date: Sep. 17, 2015

(54) Pouch-Packaged Crabmeat Product and Method

(71) Applicant: John Keeler & Co., Inc., Miami, FL (US)

(72) Inventor: John R. Keeler, Coral Gables, FL (US)

(73) Assignee: John Keeler & Co., Inc., Miami, FL (US)

(21) Appl. No.: 14/205,742

(22) Filed: Mar. 12, 2014

(51) Int. Cl. A23L 1/33; B65B 31/00; B65B 25/00; B65B 3/00

(52) U.S. Cl. CPC A23L 1/33; B65B 3/00; B65B 31/00; B65B 25/001; A23V 2002/00

(57) ABSTRACT

A packaged crabmeat product including a sealed flexible pouch, a first volume of crabmeat positioned in the sealed flexible pouch and a second volume of a gaseous component positioned in the sealed flexible pouch, the gaseous component including at least 2 percent by volume oxygen and at most 20 percent by volume oxygen, wherein the sealed flexible pouch is pasteurized.

### FIELD

This application relates to the packaging of crabmeat and, more particularly, to the packaging of crabmeat in flexible pouches.

### BACKGROUND

Crabs are caught by fishermen and are alive when brought to the dock. Live crabs are then steam cooked or boiled in order to facilitate the picking process, which consists of the separation of crabmeat from the shell and other body parts. Cooked crabs are ventilated to cool them before putting them in a temporary cooler or transferring them immediately to the picking room. In the picking room, the crabs are cleaned and the different crabmeats are picked.

The crabmeats may include jumbo lump, comprising the meat of the swimming legs; lump, comprising the muscle of the walking legs and big pieces of body meat; special, comprising the remaining body meat, most of which is shredded; claw, comprising dark meat from the claws; and cocktail claw, comprising meat from the claw attached to the moveable jaw of the claw. There are other varieties of these mentioned crabmeat types including imperial, which is very large jumbo lump from bigger than normal crabs, super lump, which is only larger pieces of lump meat, and backfin, which is a mixture of lump and special meat pieces.

Once the different crabmeats have been picked and sorted, they are finally cleaned to remove any residual shell pieces and any other matter. Then, the sorted and cleaned crabmeat is packed, sealed and processed.

Traditionally, packaged crabmeat has been sterilized or frozen, such as in metal cans, plastic cups or sealed pouches. However, both the sterilization process and the freezing process alter the texture, the taste and, in general, the fresh characteristics of the crabmeat.

Thus, pasteurization is often a more attractive heat treatment process for delicate crabmeat. For example, U.S. Pat. No. 8,337,922 issued on Dec. 25, 2012, the entire contents of which are incorporated herein by reference, discloses a method for packaging crabmeat in flexible pouches using pasteurization.

Despite advances already made, those skilled in the art continue with research and development efforts in the field of crabmeat packaging.

### SUMMARY

In one embodiment, the disclosed packaged crabmeat product may include a sealed flexible pouch, a first volume of crabmeat positioned in the sealed flexible pouch and a second volume of a gaseous component positioned in the sealed flexible pouch, the gaseous component including at least 2 percent by volume oxygen and at most 20 percent by volume oxygen, wherein the sealed flexible pouch is pasteurized.

In another embodiment, the disclosed packaged crabmeat product may include a sealed flexible pouch, a first volume of crabmeat positioned in the sealed flexible pouch and a second volume of a gaseous component positioned in the sealed flexible pouch, the gaseous component including at least 25 percent by volume oxygen, wherein the sealed flexible pouch is pasteurized.

In another embodiment, the disclosed method for packaging crabmeat may include the steps of (1) providing a flexible pouch; (2) providing a gaseous component including at least 2 percent by volume oxygen and at most 20 percent by volume oxygen; (3) placing a first volume of crabmeat into the flexible pouch; (4) placing a second volume of the gaseous component into the flexible pouch; (5) sealing the flexible pouch; and (6) after the sealing step, pasteurizing the flexible pouch.

In another embodiment, the disclosed method for packaging crabmeat may include the steps of (1) providing a flexible pouch; (2) providing a gaseous component including at least 25 percent by volume oxygen; (3) placing a first volume of crabmeat into the flexible pouch; (4) placing a second volume of the gaseous component into the flexible pouch; (5) sealing the flexible pouch; and (6) after the sealing step, pasteurizing the flexible pouch

In yet another embodiment, the amount of the gaseous component used (the magnitude of the second volume) may be based at least on the first volume (the total amount of crabmeat in the flexible pouch) and an oxygen content of the gaseous component, thereby ensuring that a sufficient amount of oxygen is present to inhibit (if not eliminate) anaerobic bacterial growth, but not too much oxygen such that the rate at which aerobic bacteria will grow is reduced.

Other embodiments of the disclosed packaged crabmeat product and method will become apparent from the following detailed description, the accompanying drawings and the appended claims.

### BRIEF DESCRIPTION OF THE DRAWINGS

FIG. 1 is a schematic cross-sectional view of one embodiment of the disclosed packaged crabmeat product;

FIG. 2 is a detailed cross-sectional view of a portion of the flexible pouch of the packaged crabmeat product of FIG. 1; and

FIG. 3 is a flow chart depicting one embodiment of the disclosed method for packaging crabmeat.

### DETAILED DESCRIPTION

Disclosed is a packaged crabmeat product. The packaged crabmeat product may include a flexible pouch that is filled with crabmeat and a corresponding amount of a gaseous component that contains a known non-zero quantity of oxygen. The filled flexible pouch may be sealed and pasteurized. After pasteurization, the sealed, pasteurized flexible pouch may be cooled to the proper storage temperature.

Significantly, the non-zero quantity of oxygen within the packaged crabmeat product may create an aerobic environment, thereby inhibiting (if not eliminating) anaerobic bacterial growth. However, the non-zero quantity of oxygen may sufficiently low to reduce the rate at which aerobic bacteria will grow and lead to spoilage of the packaged crabmeat product (as compared to bacterial growth in crabmeat exposed to the atmosphere at the same temperature). Therefore, the shelf life of the packaged crabmeat product may be prolonged without losing the ability of spoilage bacteria to reproduce and warn the consumer in the event the packaged crabmeat product is subjected to temperature abuse.

The total volume of the gaseous component within the packaged crabmeat product may be sufficiently small to prevent the flexible pouch from excessively bloating during the pasteurization process. Indeed, limiting the volume of the gaseous component in the packaged crabmeat product may reduce the risk that the flexible pouch may fail (e.g., a seal breaks) during pasteurization.

Thus, the disclosed packaged crabmeat product may retain many of its original qualities such as appearance, taste, texture, moisture, color and smell. Furthermore, the packaged crabmeat product may have an extended shelf life and a sufficient aerobic environment to inhibit (if not eliminate) the reproduction of anaerobic bacteria.

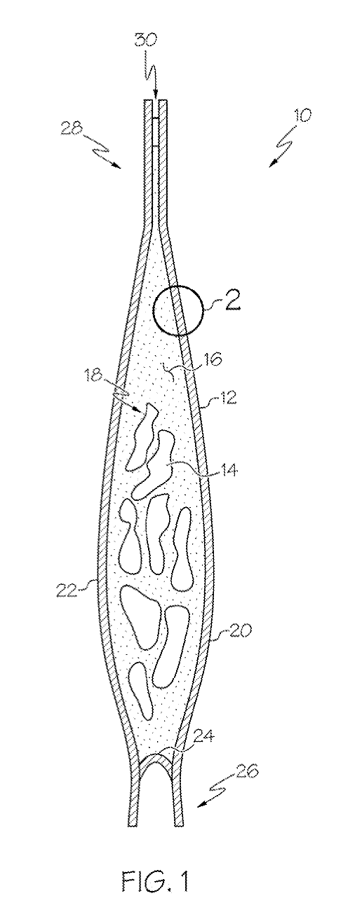

Referring to FIG. 1, one embodiment of the disclosed packaged crabmeat product, generally designated 10, may include a flexible pouch 12, crabmeat 14 and a gaseous component 16. The flexible pouch 12 may define an internal volume 18, and the crabmeat 14 and the gaseous component 16 may be sealed within the internal volume 18 of the flexible pouch 12.

The flexible pouch 12 may include a first panel member 20 sealed to a second panel member 22. For example, the first panel member 20 may be sealed to the second panel member along the periphery of each panel member 20, 22 to form the internal volume 18 between the first and second panel members 20, 22. Optionally, a base member 24 may be sealed to both the first panel member 20 and the second panel member 22 to space the first panel member 20 from the second panel member 22 proximate the lower end 26 of the flexible pouch 12.

A mouth may be initially formed proximate the upper end 28 of the flexible pouch 12. The mouth 30 may facilitate filling the internal volume 18 of the flexible pouch 12 with the crabmeat 14 and the gaseous component 16. Then, once the flexible pouch 12 has been filled, the mouth 30 may be sealed (as shown in FIG. 1) to form the final, fully sealed flexible pouch 12.

The flexible pouch 12 may be sealed with heat. However, any suitable sealing technique may be used as an alternative to heat or in addition to heat. Examples of other suitable sealing techniques include, but are not limited to, adhesive sealing, radiofrequency sealing, ultrasonic welding and the like.

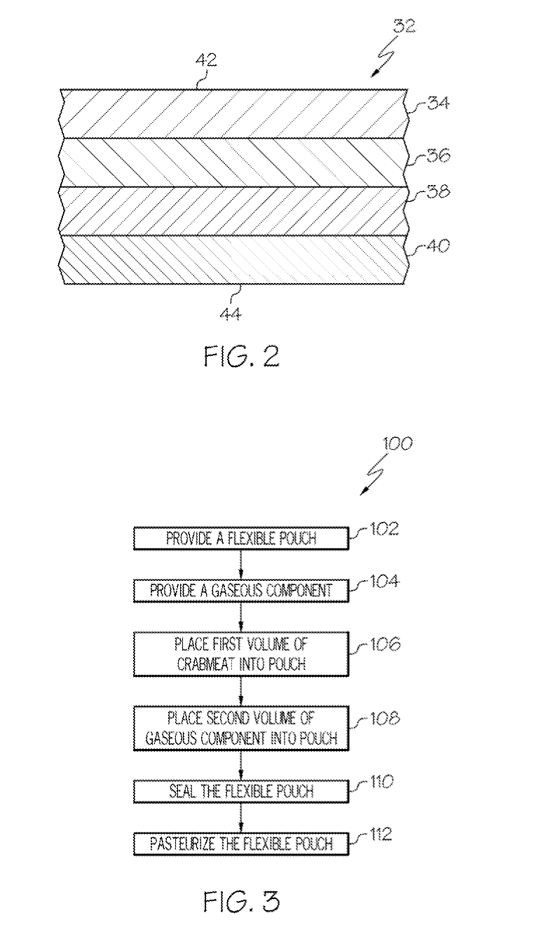

Referring to FIG. 2, in one construction, the flexible pouch 12 may be formed from a layered structure 32, such as a multi-layered film. The layered structure 32 may include an outside layer 34, which may form the outside surface 42 of the sealed flexible pouch 12, and an inside layer 40, which may form the internal surface 44 of the sealed flexible pouch 12. As one specific, non-limiting example, the layered structure 32 may include a first layer 34 of 12-micron polyethylene terephthalate (PET); a second layer 36 of 15-micron nylon; a third layer 38 of 9-micron aluminum foil; and a fourth layer 40 of 100-micron cast polypropylene (CPP). Many variations of types of film and combinations are possible. The third layer 38 (aluminum) may operate as an oxygen and light barrier helping in maintaining a longer shelf life.

Referring back to FIG. 1, the gaseous component 16 may be sealed within the flexible pouch 12 together with the crabmeat 14. Therefore, the gaseous component 16 may be a modified atmosphere gaseous component that contains a controlled quantity of oxygen sufficient to inhibit (if not eliminate) anaerobic bacterial growth, while also reducing the rate at which aerobic bacteria will grow.

In one realization, the gaseous component 16 may be a gaseous mixture including oxygen and one or more inert gases. Suitable inert gases include, but are not limited to, nitrogen, argon and helium. As one specific, non-limiting example, the gaseous component 16 may be a mixture of oxygen and nitrogen. As another specific, non-limiting example, the gaseous component 16 may be a mixture of oxygen, nitrogen and argon.

In another realization, the gaseous component 16 may be a gaseous mixture including oxygen and one or more active gases. One example of an active gas is carbon dioxide, which may increase acidity, thereby inhibiting bacterial growth. Another example of an active gas is carbon monoxide, which may act as a preservative. As one specific, non-limiting example, the gaseous component 16 may be a mixture of oxygen and carbon dioxide. As another specific, non-limiting example, the gaseous component 16 may be a mixture of oxygen and carbon monoxide.

In another realization, the gaseous component 16 may be a gaseous mixture including oxygen, one or more inert gases, and one or more active gases. As one specific, non-limiting example, the gaseous component 16 may be a mixture of oxygen, nitrogen and carbon dioxide. As another specific, non-limiting example, the gaseous component 16 may be a mixture of oxygen, nitrogen and carbon monoxide.

In yet another realization, the gaseous component 16 may consist essentially of oxygen. For example, the gaseous component 16 may be substantially pure oxygen.

Because the packaged crabmeat product 10 will be pasteurized, the quantity of the gaseous component 16 in the flexible pouch 12 may be an important factor to control. If the quantity is too high, then the gaseous component 16 will significantly expand during heating and expose the flexible pouch 12 to high stresses that may jeopardize the integrity of the flexible pouch 12. Furthermore, the excess volume will call for more space in the pasteurization chamber and, therefore, minimize productivity. Still furthermore, expanding flexible pouches may be forced by pressure to come into contact with the walls of the pasteurization unit, which may cause damage. However, the quantity of the gaseous component 16 should be sufficiently high to provide the amount of oxygen necessary to inhibit (if not eliminate) anaerobic bacterial growth, while also reducing the rate at which aerobic bacteria will grow.

Thus, when a first volume of the crabmeat 14 is used, a second volume of the gaseous component 16 may be used, wherein the second volume may be a function of the first volume as well as the oxygen content of the gaseous component 16. Less of the gaseous component 16 may be used when the gaseous component 16 contains a higher percentage of oxygen. In one expression, the second volume may be at most about 50 percent of the first volume. In another expression, the second volume may be at most about 40 percent of the first volume. In another expression, the second volume may be at most about 30 percent of the first volume. In another expression, the second volume may be at most about 20 percent of the first volume. In another expression, the second volume may be at most about 10 percent of the first volume. In yet another expression, the second volume may be at most about 5 percent of the first volume.

In a first implementation, the gaseous component 16 may contain less oxygen than ambient air. In one expression of the first implementation, the gaseous component 16 may include at least about 2 percent by volume oxygen and at most about 20 percent by volume oxygen. In another expression of the first implementation, the gaseous component 16 may include at least about 2 percent by volume oxygen and at most about 15 percent by volume oxygen. In another expression of the first implementation, the gaseous component 16 may include at least about 2 percent by volume oxygen and at most about 10 percent by volume oxygen. In another expression of the first implementation, the gaseous component 16 may include at least about 2 percent by volume oxygen and at most about 7 percent by volume oxygen. In yet another expression of the first implementation, the gaseous component 16 may include at least about 3 percent by volume oxygen and at most about 5 percent by volume oxygen.

In a second implementation, the gaseous component 16 may contain more oxygen than ambient air. In one expression of the second implementation, the gaseous component 16 may include at least about 25 percent by volume oxygen. In another expression of the second implementation, the gaseous component 16 may include at least about 30 percent by volume oxygen. In another expression of the second implementation, the gaseous component 16 may include at least about 40 percent by volume oxygen. In another expression of the second implementation, the gaseous component 16 may include at least about 50 percent by volume oxygen. In another expression of the second implementation, the gaseous component 16 may include at least about 60 percent by volume oxygen. In another expression of the second implementation, the gaseous component 16 may include at least about 70 percent by volume oxygen. In another expression of the second implementation, the gaseous component 16 may include at least about 80 percent by volume oxygen. In another expression of the second implementation, the gaseous component 16 may include at least about 90 percent by volume oxygen. In yet another expression of the second implementation, the gaseous component 16 may be substantially 100 percent oxygen.

At this point, those skilled in the art will appreciate that the volume of the gaseous component 16 required for a given volume of crabmeat 14 will decrease as the oxygen content of the gaseous component 16 increases. Similarly, the volume of the gaseous component 16 required for a given volume of crabmeat 14 will increase as the oxygen content of the gaseous component 16 decreases. As one example, the volume of the gaseous component 16 may be at most about 40 percent of the volume of crabmeat 14 when the gaseous component contains about 10 percent by volume oxygen. As another example, the volume of the gaseous component 16 may be at most about 20 percent of the volume of crabmeat 14 when the gaseous component contains about 20 percent by volume oxygen. As yet another example, the volume of the gaseous component 16 may be at most about 5 percent of the volume of crabmeat 14 when the gaseous component contains about 100 percent by volume oxygen.

Once the crabmeat 14 and the gaseous component 16 have been sealed in the flexible pouch 12, the sealed flexible pouch 12 may be pasteurized. The pasteurization step may destroy pathogenic microorganisms and spores while maintaining the fresh appearance and texture of the crabmeat 14. Pasteurization times and temperatures vary depending on the vessel type, initial temperature of the crabmeat 14, as well as many other variables. As one specific, non-limiting example, a pasteurization time of about 80 to 160 minutes at a temperature of about 185 to 189° F. may be used for one pound of crabmeat packaged in a flexible pouch.

The final pasteurized packaged crabmeat product 10 may be held under refrigeration until consumed, as is well known in the art.

Referring to FIG. 3, also disclosed is a method, generally designated 100, for packaging crabmeat. The method 100 may begin at Block 102 with the step of providing a flexible pouch. The flexible pouch may include a mouth for filling the pouch.

At Block 104, a gaseous component may be provided. For example, the gaseous component may be sourced from a supplier or prepared on site. The gaseous component may have an oxygen content that is different from an oxygen content of ambient air. In one implementation, the gaseous component may be a gaseous mixture that contains a non-zero quantity of oxygen, but less oxygen than ambient air. For example, the oxygen content of the gaseous component may range from about 2 percent by volume to about 20 percent by volume. In another implementation, the gaseous component may contain more oxygen than ambient air. As one example, the oxygen content of the gaseous component may be at least 25 percent by volume. As another example, the oxygen content of the gaseous component may be substantially 100 percent.

At Block 106, the first volume of crabmeat may be placed into the flexible pouch. At Block 108, a second volume of the gaseous component may be placed into the flexible pouch. The order of Blocks 106 and 108 may be reversed without departing from the scope of the present disclosure. The magnitude of the second volume may depend on, among other possible factors, the magnitude of the first volume and the oxygen content of the gaseous component.

At Block 110, the flexible pouch may be sealed, thereby sealing the crabmeat and the gaseous component in the flexible pouch. Then, at Block 112, the sealed flexible pouch may be pasteurized.

Although various embodiments of the disclosed packaged crabmeat product and method have been shown and described, modifications may occur to those skilled in the art upon reading the specification. The present application includes such modifications and is limited only by the scope of the claims.

What is claimed is:

1. A packaged crabmeat product comprising:
a sealed flexible pouch;
a first volume of crabmeat positioned in said sealed flexible pouch; and
a second volume of a gaseous component positioned in said sealed flexible pouch, said gaseous component being manmade and comprising at least 2 percent by volume oxygen and at most 20 percent by volume oxygen,
wherein said sealed flexible pouch is pasteurized.

2. The packaged crabmeat product of claim 1 wherein said flexible pouch comprises a multi-layer film.

3. The packaged crabmeat product of claim 1 wherein said flexible pouch comprises a layered structure that comprises:
at least one layer of polyethylene terephthalate;
at least one layer of nylon;
at least one layer of aluminum; and
at least one layer of cast polypropylene.

4. The packaged crabmeat product of claim 1 wherein said gaseous component comprises at most 10 percent by volume oxygen.

5. The packaged crabmeat product of claim 1 wherein said gaseous component comprises at least 3 percent by volume oxygen.

6. The packaged crabmeat product of claim 1 wherein said gaseous component further comprises an inert gas.

7. The packaged crabmeat product of claim 6 wherein said gaseous component further comprises an active gas.

8. The packaged crabmeat product of claim 1 wherein said second volume is at most about 20 percent of said first volume.

9. The packaged crabmeat product of claim 1 wherein said second volume is at most about 10 percent of said first volume.

10. A packaged crabmeat product comprising:
a sealed flexible pouch;
a first volume of crabmeat positioned in said sealed flexible pouch; and
a second volume of a gaseous component positioned in said sealed flexible pouch, said gaseous component being manmade and comprising at least 25 percent by volume oxygen,
wherein said sealed flexible pouch is pasteurized.

11. The packaged crabmeat product of claim 10 wherein said flexible pouch comprises a multi-layer film.

12. The packaged crabmeat product of claim 10 wherein said flexible pouch comprises a layered structure that comprises:
at least one layer of polyethylene terephthalate;
at least one layer of nylon;
at least one layer of aluminum; and
at least one layer of cast polypropylene.

13. The packaged crabmeat product of claim 10 wherein said gaseous component comprises at least 50 percent by volume oxygen.

14. The packaged crabmeat product of claim 10 wherein said gaseous component comprises at least 90 percent by volume oxygen.

15. The packaged crabmeat product of claim 10 wherein said gaseous component further comprises an inert gas.

16. The packaged crabmeat product of claim 15 wherein said gaseous component further comprises an active gas.

17. The packaged crabmeat product of claim 10 wherein said gaseous component consists essentially of oxygen.

18. The packaged crabmeat product of claim 10 wherein said second volume is at most about 20 percent of said first volume.

19. A method for packaging crabmeat comprising the steps of:
providing a flexible pouch;
providing a gaseous component comprising an oxygen content, wherein said oxygen content is different than an oxygen content of ambient air;
placing a first volume of crabmeat into said flexible pouch;
placing a second volume of said gaseous component into said flexible pouch;
sealing said flexible pouch; and
after said sealing step, pasteurizing said flexible pouch.

20. The method of claim 19 further comprising, prior to said step of placing said second volume, determining a magnitude of said second volume based on said first volume and said oxygen content of said gaseous component.
